(19) United States
(12) Patent Application Publication
(10) Pub. No.: US 2009/0188154 A1
(43) Pub. Date: Jul. 30, 2009

(54) Adjustable-Trigger Gopher Trap

(76) Inventors: Donald R. Boys, Aromas, CA (US); Dale Holderman, Santa Cruz, CA (US)

Correspondence Address: CENTRAL COAST PATENT AGENCY, INC, 3 HANGAR WAY SUITE D, WATSONVILLE, CA, 95076, US

(21) Appl. No.: 12/019,896

(22) Filed: Jan. 25, 2008

(51) Int. Cl. A01M 23/24

(52) U.S. Cl. 43/81.5; 43/81

(57) ABSTRACT

A gopher trap comprising has a first elongated body element pivotally attached at a substantially central point to a second elongated body element, a jaw structure at one end of each of the first and the second body elements such that the jaws close together by relative rotation of the body elements, a spring element placed to urge the first and second body elements apart on a side of the pivot point opposite the jaw elements, a moveable trigger mechanism spanning the two body elements on the jaw side of the pivot point, such that the trigger mechanism holds the jaws open until the trigger mechanism is tripped in a first direction, a tripping mechanism on the jaw side of the pivot point comprising a pivoted paddle extending forward and upward from a paddle pivot joined to one of the body elements, and a trip point that touches the movable trigger mechanism on one side, such that moving the paddle upward moves the trip point in the first direction. With the jaw end of the trap placed in a gopher run, dirt pushed toward the trap will raise the paddle and trip the trigger mechanism, causing the jaws to close with force provided by the spring element urging the body elements apart.

### BACKGROUND OF THE INVENTION

1. Field of the Invention

This invention is in the broad field of rodent traps, and pertains more particularly to a specialized gopher trap that has a trigger with adjustable sensitivity.

2. Description of Related Art

The effect of gophers on such as landscaping and golf courses is notoriously well known in the art, and many patents have been issued for traps to capture and kill gophers. The fact that there is still unmet need, however, is well attested by the fact that people are still looking for new and better ways to deal with the population of gophers.

It is well known that most gopher traps are designed to take advantage of the behavior of gophers to close any openings in their runs. Gopher runs can often be rather easily discovered by the mounding of earth above the tunnel if the tunnel is just below the surface. If one opens the run, and it is an active run, the gopher will attempt to close the opening. So most traps are made with spring-loaded mechanisms that may be set to present an open jaw just inside the opening with a sensor to detect the approach of the gopher and a trigger tripped by the sensor to quickly close the jaw, and impale or trap the gopher. The well-known Macabee trap is a case in point. The Macabee impales the gopher. Other jaw-type traps simply close on the gopher and hold it until a person retrieves the trap.

The present inventors have discovered and noted faults common to the type of traps described above. One fault is that all traps of this type have trips that are designed to be activated by the gopher. But the gopher seldom encounters such a trip, because the habit of the gopher is to push dirt ahead and into the opening. So the usual situation is that soft dirt is pushed against the trip, and the trip is quite often insensitive enough that it simply gets covered, and the opening becomes closed without ever trapping the gopher. Another fault is that gopher traps are used in gopher runs, and so are often exposed to moisture and dirt, and the mechanisms of the traps are subject to the dirt and corrosion. A trip that is sensitive and workable originally may later be very stiff and difficult to activate.

What is clearly needed is a gopher trap with a trip mechanism made to sense the dirt that the gopher pushes, rather than the gopher, and that is provided with a sensitivity adjustment, so the sensitivity in use may always be kept at a maximum level.

### BRIEF SUMMARY OF THE INVENTION

In development and research efforts the inventors have discovered some important issues not before seriously considered in the design of gopher traps. One issue is that it is seldom the gopher that trips a trap; it is more often the dirt pushed by the gopher to close the opening in a run where the trap is set, and a trigger mechanism may serve best that is arranged to sense the mound of dirt pushed forward by the gopher. Another is that the dirt is usually thin and granular, and the trigger for the trap must be very sensitive. A third is that such traps are usually open to the elements, to dirt, and are subject to corrosion, and a mechanism of the trap may not operate exactly the same over time.

Accordingly the inventors have provided in one embodiment a gopher trap comprising a first elongated body element pivotally attached at a substantially central point to a second elongated body element, a jaw structure at one end of each of the first and the second body elements such that the jaws close together by relative rotation of the body elements, a spring element placed to urge the first and second body elements apart on a side of the pivot point opposite the jaw elements, a moveable trigger mechanism spanning the two body elements on the jaw side of the pivot point, such that the trigger mechanism holds the jaws open until the trigger mechanism is tripped in a first direction, a tripping mechanism on the jaw side of the pivot point comprising a pivoted paddle extending forward and upward from a paddle pivot joined to one of the body elements, and a trip point that touches the movable trigger mechanism on one side, such that moving the paddle upward moves the trip point in the first direction;

wherein, with the jaw end of the trap placed in a gopher run, dirt pushed toward the trap will raise the paddle and trip the trigger mechanism, causing the jaws to close with force provided by the spring element urging the body elements apart.

In one embodiment the trap further comprises an adjustable spring mechanism attached to the trigger mechanism for providing an adjustable force to the trigger mechanism in the first direction.

Also in one embodiment the trigger mechanism is a linkage with a first link element pivoted on the first body element at one end and at the opposite end to a first end of a second link element, with the second link element pivoted on the second body element, such that urging the body elements together on the side of the trap opposite the jaw side straightens the linkage.

Also in one embodiment the trap includes a stop pin in one of the body elements near the trigger mechanism linkage, the stop pin positioned such that a user, setting the trap, may move the linkage past center against the stop pin, at which position the trap remains set when the user releases the body elements.

In another aspect of the invention a method for sensitizing a trip element of a gopher trap is provided, comprising steps of (a) attaching an adjustable spring mechanism to the trip element, the spring mechanism applying spring force in a direction to spring the trap; and (b) adjusting the spring force with the adjustable mechanism until the trip element as at the point of tripping.

In yet another embodiment a gopher trap is provided comprising a first elongated body element pivotally attached at a substantially central point to a second elongated body element, a jaw structure at one end of each of the first and the second body elements such that the jaws close together by relative rotation of the body elements, a spring element placed to urge the first and second body elements apart on a side of the pivot point opposite the jaw elements, a trigger mechanism spanning the two body elements at an end furthest from the jaws, the trigger mechanism comprising a first linear element joined to the first body element, and a second linear element pivoted to the first linear element at an end of the first linear element furthest from the first body element; and a movable retainer clip coupled to a trip mechanism on the jaw side of the trap for retaining the second linear element of the trigger mechanism, and for springing the trap. The trigger mechanism may be folded around a pin in an end of the second body element with the second linear element placed under the movable clip, such that moving the clip releases the second linear element, unfolding the trigger mechanism allowing the jaws to close.

In another embodiment the trip mechanism comprises a pusher paddle at the jaw end of the trap, the pusher paddle connected to a push rod along the length of the trap, connected at the far end to the retainer clip, such that a gopher, or earth pushed by the gopher against the paddle will move the retainer clip and release the trigger mechanism.

In yet another embodiment the trip mechanism comprises a pivoted paddle extending at an upward angle toward the jaw end on the jaw side of the trap, with a pusher element positioned to urge the push rod in the direction away from the jaw end as the paddle is rotated upward.

### BRIEF DESCRIPTION OF THE SEVERAL VIEWS OF THE DRAWINGS

FIG. 1 is a plan view of a gopher trap in an embodiment of the present invention.

FIG. 2 is an elevation view of the trap of FIG. 1 from one end.

FIG. 3 is an elevation view of the trap of FIG. 1 from a side.

FIG. 4 is a plan view showing the trap tripped.

FIG. 5 is a plan view of a gopher trap in an embodiment of the invention, with an alternative trigger mechanism.

FIGS. 6a-6d illustrate another embodiment of a gopher trap in an embodiment of the invention.

### DETAILED DESCRIPTION OF THE INVENTION

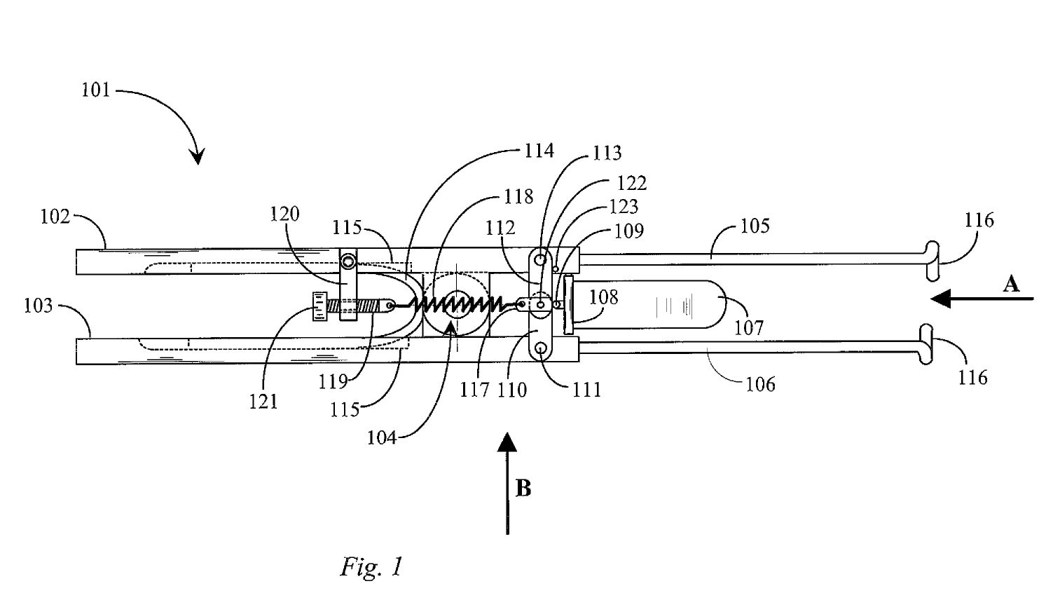

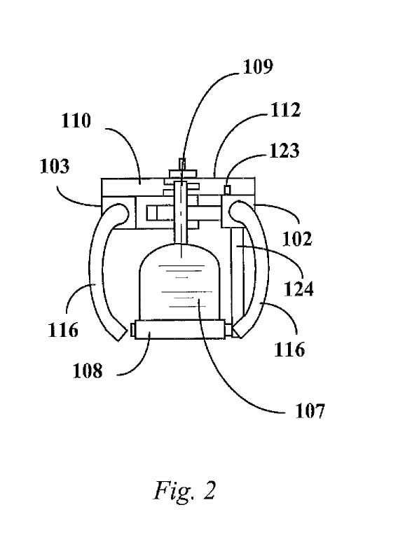

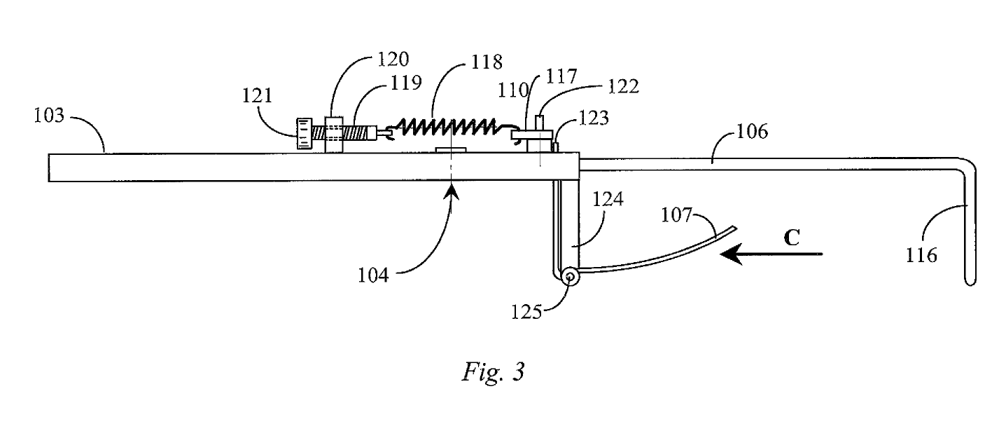

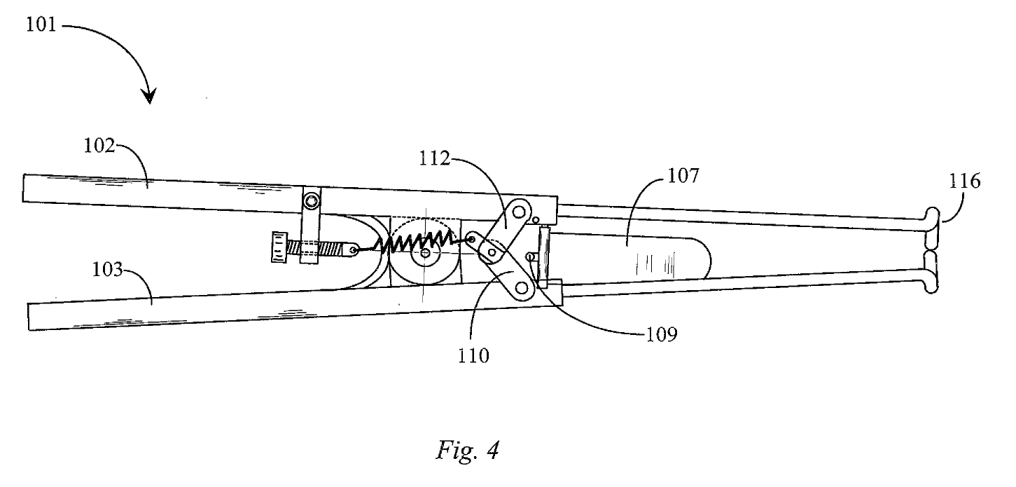

FIG. 1 is a plan view of a gopher trap 101 in an embodiment of the present invention. FIG. 2 is an elevation view of trap 101 in the direction of arrow A of FIG. 1. FIG. 3 is an elevation view of trap 101 in the direction of arrow B of FIG. 1. FIG. 4 is a plan view in the same aspect as FIG. 1, except in FIG. 4 the trap is tripped, and in FIG. 1 it is set. Reference to each of FIGS. 1-4 is necessary to describe the design and operation of trap 101.

Referring to FIG. 1, trap 101 comprises body elements 102 and 103 pivoted at a point 104. In the embodiment shown element 102 has a planar extension that engages a slot in an extension of element 103, and a pivot shaft passes through both planar extensions providing the pivoting relationship. This pivot may be accomplished in a number of different ways, and the design shown is but one variation. Rod element 105 engages a bore in element 102, and ends in a jaw element 116. Another rod element 105 engages a bore in element 103, also ending in a jaw element 116. A U-shaped, strong spring 114 urges elements 102 and 103 apart on one side of pivot 104, which tends to close jaw elements 116 until they touch. The shape of the jaw elements 116 and their relationship with the trap open, that is, set, can best be seen in FIG. 2.

A linkage comprising link elements 110 and 112, with element 110 pivoted at body element 103 on a pin 111, element 112 pivoted at body element 102 on pin 113, and the two link elements pivotally joined at the ends furthest from the body elements, provides a mechanism for setting and activating the trap. If a user grasps body elements 102 and 103 and asserts inward pressure against U-shaped spring 114, the jaws 116 open until the link mechanism is straight as shown in FIG. 1, at which point the trap cannot open further. A user may at this point engage push pin 123 to move the linkage mechanism slightly past center until element 112 touches pin 123. In this condition the trap will stay open, because the force of spring 114 will tend to move the linkage of elements 110 and 112 toward pin 123.

A sensor paddle 107 joined to a hollow shaft 108 engages a pivot pin 125 which extends from a bracket element 124 joined to body element 102. When trap 101 is placed jaw first in a gopher run and a gopher pushes dirt toward the opening of the run into which the trap is placed, the sensor paddle is located near the bottom of the run, and at an aspect extending forward into the run at a shallow upward angle, so the dirt pushed forward by the gopher will lift paddle 107.

A rod 109 is joined to hollow shaft 108 in an aspect that a tip of the rod bears against the link mechanism comprising links 110 and 112, such that any force tending to push paddle 107 upward will cause rod 109 to urge against the linkage mechanism. Sufficient force against paddle 107 and movement of the paddle upward will thus cause the linkage mechanism to fold toward the main pivot point of the trap. As the linkage begins to fold the considerable force of spring 114, tending to close the jaws of the trap, will cause the jaws to close very quickly.

In use the jaws end of the trap is inserted through an opening into a gopher run and left in place with the opening remaining open. As a gopher pushes dirt towards the light from the opening, the dirt is pushed in the direction of arrow C of FIG. 3, and accumulates under paddle 107, pushing the paddle upward, which rotates around pin 125, and urges rod 109 against the trip linkage, but the force necessary to lift paddle 107 to trip the linkage is relatively large, and the dirt pushed forward is typically soft and granular. It is therefore desirable that the trigger be very sensitive, and that it should take little force against paddle 107 to trip the linkage and cause the jaws of the trap to close.

To ensure maximum sensitivity a tension spring 118 engages a hole in bracket 117 on link 112 at one end, and a hole in a rotatable head on a threaded shaft 119 having a knob 121. The threaded shaft engages female threads in a bracket 120 attached to body element 102, such that rotating the threaded shaft in one rotary direction extends spring 118, presenting force in the trip direction (toward the main pivot point) against the trip linkage. At some point in increasing the spring tension the tension will move the linkage against whatever inertia and friction tends to keep the linkage unmoving, and the trap will trip. At a just slightly smaller force the linkage will remain unmoving, but only a very small force, contributed by rod 109 as a gopher pushes dirt under paddle 107, will then trip the linkage and cause the trap to close.

The inventors know that the amount of force necessary to trip the trap in this embodiment will never remain constant over a long period of time. Instead, dirt, corrosion, and other variables will make the trap harder to trip over time. Therefore a preferred procedure for setting this trap is to squeeze body element 102 and 103 together until the linkage of elements 110 and 112 is straight, then to push the linkage past center and against pin 123 by pushing pin 122. The trap will remain set when the body elements are released. The next step is to rotate knob 121 to lengthen spring 118, pulling on the linkage, until the trap trips. Now rotate knob 121 in the other rotary direction by one-half to one turn. Then the trap is reset, and the trigger has the maximum sensitivity. If the trap will not remain set, the procedure may be repeated until the trap will stay set.

It is emphasized that pin 125 engages bracket 124, which is joined to body element 102 only, although it might be mounted to body element 103 only. This is because the body elements change relative position when the trap is tripped, and if pin 125 were to be mounted to brackets joined to both body element, the trap could not close. For similar reasons bracket 117 is mounted only to linkage element 112, although it may be mounted to only element 110.

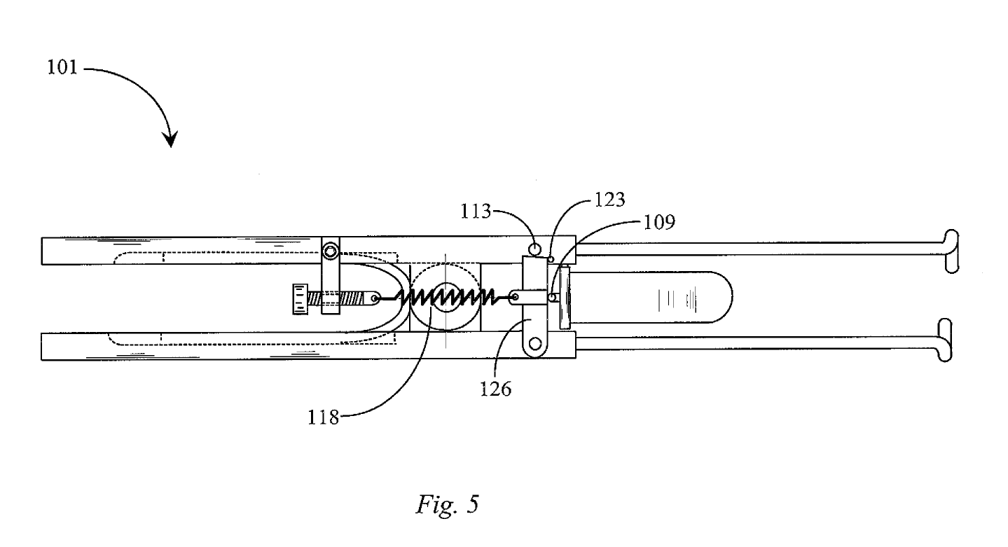

In another embodiment the trip linkage might be implemented differently. FIG. 5 is a plan view of an alternative embodiment wherein a single trip element 126 is pivoted on one of the body elements and holds the trap open against pin 113. The end of element 126 is slightly angled at the end that engages pin 113, and spring 118 pulls against bracket 117 joined to element 126. In this embodiment there may simply be a hole in element 126 for the spring. It will be apparent that there are other ways the trigger linkage may be implemented as well.

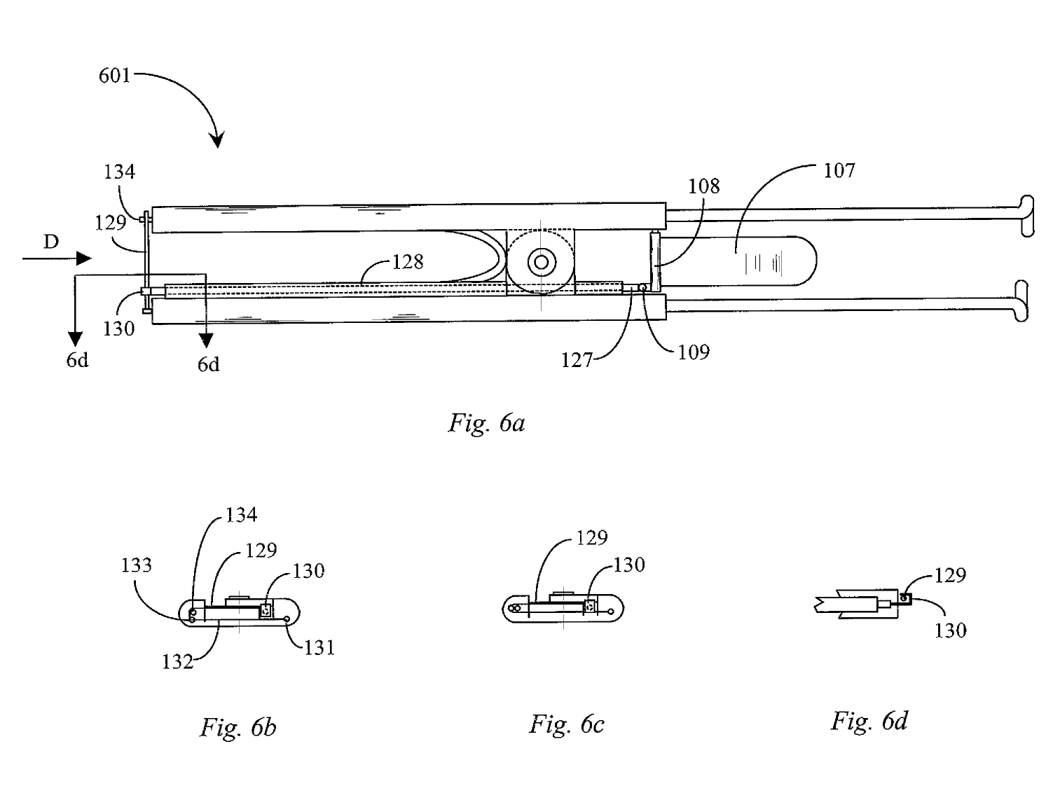

In another aspect of the invention a mechanism for setting and activating the trap is implemented at the ends of body elements 102 and 103. FIG. 6a is a plan view of a gopher trap 601 in this alternative embodiment. The setting and activating mechanism is illustrated in FIGS. 6a through 6c. A pin 131 on an end of body element 103 anchors a wire element 132 which extends toward body element 102 and connects pivotally to another wire element 129. The assembly of wire elements 132 and 129 folds around a pin 134 in the end of body element 102 to hold the trap set against force of strong spring 114. In one embodiment the pivot between element 132 and 129 is below pin 134, and element 129 is curved around pin 134 (FIG. 6b). In another embodiment element 132 and element 129 are substantially straight, and when the assembly is folded around pin 134 pivot 133 lies adjacent pin 134.

In both embodiments shown the force of spring 114 urging the body elements apart (and the jaws closed) asserts some rotational force to cause wire element 129 to lift. If wire element 129 is not constrained after the trap is set, the trap will immediately spring. In these embodiments a tubing 128 is provided along an inside edge of body element 103, and a pusher rod 127 slides within tubing 128. One end of pusher rod 127 lies adjacent rod 109 (repositioned from previous embodiments), which extends from shaft 108 turned by sensor panel 107 by dirt pushed by a gopher. Raising of paddle 107 causes rod 127 to translate in tubing 128, which moves a retainer clip 130.

When body elements 102 and 103 are squeezed together to set the trap, a user folds the mechanism of elements 132 and 129 around pin 134, and places the free end of element 129 under clip 130 as shown in FIG. 6d. The user can move clip 130 as needed to accomplish setting the trap. Element 129 is thus restrained, and the trap remains set until a gopher trips the trap by pushing dirt under paddle 107, moving clip 130 to release element 129, which flips upward, releasing the restraint between body elements 102 and 103 and allowing the jaws to close. In an alternative embodiment a simple push paddle connected to rod 127 may be used instead of the pivoted paddle 107. The push paddle may be pushed rearward to release the folded mechanism by either a gopher approaching the opening in the run where the trap is set, or by dirt pushed by the gopher.

It will be apparent to the skilled artisan that the embodiments and examples described above are not the only embodiments of the invention, and that many alterations and amendments may be made without departing from the spirit and scope of the invention. The invention is therefore limited only by the claims that follow.

I claim:

1. A gopher trap comprising:
a first elongated body element pivotally attached at a substantially central point to a second elongated body element;
a jaw structure at one end of each of the first and the second body elements such that the jaws close together by relative rotation of the body elements;
a spring element placed to urge the first and second body elements apart on a side of the pivot point opposite the jaw elements;
a moveable trigger mechanism spanning the two body elements on the jaw side of the pivot point, such that the trigger mechanism holds the jaws open until the trigger mechanism is tripped in a first direction; and
a tripping mechanism on the jaw side of the pivot point comprising a pivoted paddle extending forward and upward from a paddle pivot joined to one of the body elements, and a trip point that touches the movable trigger mechanism on one side, such that moving the paddle upward moves the trip point in the first direction;
wherein, with the jaw end of the trap placed in a gopher run, dirt pushed toward the trap will raise the paddle and trip the trigger mechanism, causing the jaws to close with force provided by the spring element urging the body elements apart.

2. The trap of claim 1 further comprising an adjustable spring mechanism attached to the trigger mechanism for providing an adjustable force to the trigger mechanism in the first direction.

3. The trap of claim 1 wherein the trigger mechanism is a linkage with a first link element pivoted on the first body element at one end and at the opposite end to a first end of a second link element, with the second link element pivoted on the second body element, such that urging the body elements together on the side of the trap opposite the jaw side straightens the linkage.

4. The trap of claim 3 including a stop pin in one of the body elements near the trigger mechanism linkage, the stop pin positioned such that a user, setting the trap, may move the linkage past center against the stop pin, at which position the trap remains set when the user releases the body elements.

5. A method for sensitizing a trip element of a gopher trap, comprising steps of:
(a) attaching an adjustable spring mechanism to the trip element, the spring mechanism applying spring force in a direction to spring the trap; and
(b) adjusting the spring force with the adjustable mechanism until the trip element as at the point of tripping.

6. A gopher trap comprising:
a first elongated body element pivotally attached at a substantially central point to a second elongated body element;
a jaw structure at one end of each of the first and the second body elements such that the jaws close together by relative rotation of the body elements;
a spring element placed to urge the first and second body elements apart on a side of the pivot point opposite the jaw elements;
a trigger mechanism spanning the two body elements at an end furthest from the jaws, the trigger mechanism comprising a first linear element joined to the first body element, and a second linear element pivoted to the first linear element at an end of the first linear element furthest from the first body element; and
a movable retainer clip coupled to a trip mechanism on the jaw side of the trap for retaining the second linear element of the trigger mechanism, and for springing the trap;
wherein the trigger mechanism may be folded around a pin in an end of the second body element with the second linear element placed under the movable clip, such that moving the clip releases the second linear element, unfolding the trigger mechanism allowing the jaws to close.

7. The gopher trap of claim 6 wherein the trip mechanism comprises a pusher paddle at the jaw end of the trap, the pusher paddle connected to a push rod along the length of the trap, connected at the far end to the retainer clip, such that a gopher, or earth pushed by the gopher against the paddle will move the retainer clip and release the trigger mechanism.

8. The gopher trap of claim 6 wherein the trip mechanism comprises a pivoted paddle extending at an upward angle toward the jaw end on the jaw side of the trap, with a pusher element positioned to urge the push rod in the direction away from the jaw end as the paddle is rotated upward.
